(19) United States
(12) Patent Application Publication
(10) Pub. No.: US 2014/0162145 A1
(43) Pub. Date: Jun. 12, 2014

(54) OPERATING A METAL-AIR BATTERY

(71) Applicant: Battelle Memorial Institute, Columbus, OH (US)

(72) Inventors: Jay R. Sayre, New Albany, OH (US); Megan Sesslar Moore, HIlliard, OH (US); Vince D. McGinniss, Columbus, OH (US)

(21) Appl. No.: 14/182,084

(22) Filed: Feb. 17, 2014

Related U.S. Application Data
(63) Continuation of application No. 12/990,430, filed on Jan. 6, 2011.
(60) Provisional application No. 61/049,050, filed on Apr. 30, 2008.

(51) Int. Cl. H01M 12/06

(52) U.S. Cl. CPC H01M 12/065
USPC 429/404

(57) ABSTRACT

Methods for operating open electrochemical cells are disclosed. The open electrochemical cells generally comprise a cathode, an electrolyte, and an anode. One example cathode comprises: (i) a catalyst; (ii) an electronic conductor and (iii) a hydrophobic gas permeable binder. The open electrochemical cells may be operated as metal-air batteries, for example, in devices comprising the open electrochemical cells.

### CROSS-REFERENCE TO RELATED APPLICATIONS

This application is the continuation of U.S. patent application Ser. No. 12/990,430, filed Jan. 6, 2011, which is the national stage filing of PCT/US2009/042354, filed Apr. 30, 2009, which claims priority from U.S. Provisional Patent Application No. 61/049,050, filed on Apr. 30, 2008. Each of the above-referenced applications is incorporated by reference herein in its entirety.

### BACKGROUND

The development of relatively small, portable, electrically-powered functional devices such as, for example, cellular phones, voice recording and playing devices, watches, motion and still cameras, liquid crystal displays, electronic calculators, IC cards, temperature sensors, hearing aids, pressure sensitive buzzers, transmitters of various types, and the like, has generated a need for compact thin layer batteries.

The present application describes embodiments of metal-air batteries that are suitable for use in such devices, and that at least partially alleviate gas accumulation and cathode consumption issues typical of primary alkaline batteries.

### SUMMARY

In one embodiment, an open electrochemical cell is provided, the open electrochemical cell comprising:

(a) a cathode, comprising:
(i) a catalyst;
(ii) an electronic conductor; and
(iii) a hydrophobic gas permeable binder;

(b) an electrolyte; and

(c) an anode.

In another embodiment, a cathode for use in a rechargeable battery is provided, the cathode comprising: a catalyst, an electronic conductor, and a hydrophobic gas permeable binder, wherein the cathode is supported on a porous electronically conductive support material in a continuous phase.

In another embodiment, a functional device is provided, the functional device comprising:

an open electrochemical cell, comprising:
(a) a cathode comprising a catalyst and an electronic conductor operatively connected by a hinder, the binder being hydrophobic and gas permeable;
(b) an electrolyte, comprised of electrolyte material; and
(c) an anode, comprised of anode material;

wherein the open electrochemical cell is rechargeable by adding at least one of electrolyte material and anode material to the open electrochemical cell.

### BRIEF DESCRIPTION OF THE DRAWINGS

The accompanying figures, which are incorporated in and constitute a part of the specification, illustrate various example systems, methods, results, and so on, and are used merely to illustrate various example embodiments. It should be noted that various components depicted in the figures may not be drawn to scale, and that the various shapes (e.g., rectangular, square) depicted in the figures are presented for purposes of illustration only, and should not be considered in any way as limiting.

FIG. 1 illustrates an example embodiment of an open electrochemical cell in the configuration of a metal-air battery.

FIG. 2 illustrates an example embodiment of several example components of a metal-air battery prior to assembly.

FIG. 3 illustrates an example embodiment of a single cell metal-air battery in an example testing fixture.

FIG. 4 illustrates an example embodiment of three single cell metal-air batteries in series in an example testing fixture.

FIG. 5 illustrates example results of a zinc-air single cell electrochemical discharge curve at 750 μA constant current discharge.

FIG. 6 illustrates example results of an aluminum-air single cell electrochemical discharge curve at 750 μA constant current discharge.

### DETAILED DESCRIPTION

The present application describes embodiments of metal-air batteries that are suitable for use in relatively small, portable, electrically-powered functional devices. The metal-air batteries described in the present application at least partially alleviate gas accumulation and cathode consumption issues typical of primary alkaline batteries.

In one embodiment, an open electrochemical cell is provided, the open electrochemical cell comprising:

(a) a cathode, comprising:
(i) a catalyst;
(ii) an electronic conductor; and
(iii) a hydrophobic gas permeable binder;

(b) an electrolyte; and

(c) an anode,

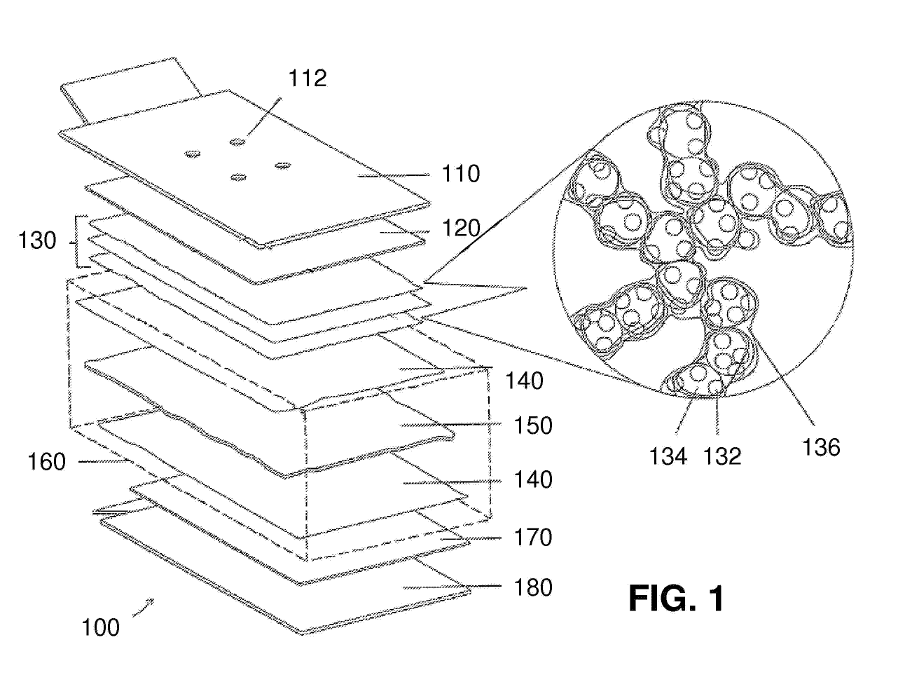

FIG. 1 illustrates an example embodiment of an open electrochemical cell in the configuration of an open-cell, laminated metal-air battery 100. As shown, metal-air battery 100 comprises a cathode current collector 110 having air access holes 112. Cathode current collector 110 may be comprised of, for example, stainless steel, nickel, gold, nickel-clad stainless steel, nickel-plated stainless steel, Inconel® alloys (manufactured by Special Metals Corporation), and other noncorrosive materials that minimze contact resistance. In FIG. 1, cathode current collector 110 is depicted as having four access holes 112 and battery 100 is depicted as being rectangular in shape. It will be readily apparent to a person having ordinary skill in the art that cathode current collector 110 may have any number of access holes 112 and battery 100 may be configured in any geometrical shape.

As depicted in FIG. 1, the construction of battery 100 is distinguishable over typical metal-air batteries consisting of metal can halves that house and crimp together the cathode and anode active materials. First, the crimped-can design requires special consideration of volume to ensure that the can is able to handle gas accumulation. Also, the crimped-can design does not permit mechanical recharging. In contrast, the open cell laminate design depicted in FIG. 1 allows gas products to escape, and permits mechanical recharging by allowing ready replacement of the discharged anode material and electrolyte material,

Metal-air battery 100 may further comprise a semi-permeable membrane 120 that maintains a gas-permeable waterproof boundary between the air and the cell's electrolyte. Semi-permeable membrane 120 may be comprised of, for example, expanded polytetrafluoroethylene (PTFE), cellulose nitrate, cellulose acetate, polysulfone, aramids, polyvinylidene fluoride, acrylonitrile polymers and copolymers, regenerated cellulose, cellulose acetate, ethylene-polyvinyl alcohol, polyacrylonitrile, polycarbonate, polymethylmethacrylate, polyperfluoro (ethylene-co-ethylene sulfonic acid), and polysulfone. Semi-permeable membrane 120, as depicted in battery 100 in FIG. 1, is shown as a single layer. It is also contemplated that semi-permeable membrane 120 may be constructed in two or more layers, with at least one layer acting as a barrier layer to prevent fluid from exiting battery 100 (i.e., a waterproof boundary), and at least one layer providing gas-permeability to alleviate gas accumulation. In one embodiment, such a two (or more) ply system may be constructed with the barrier layer and the air diffusion layer directly contiguous to each other and between a cathode 130 and cathode current collector 110. This is in contrast to a two (or more) ply system wherein the barrier layer and the air diffusion layer are not contiguous to each other and, instead, sandwich cathode 130.

As shown in FIG. 1, cathode 130 may be comprised of a dispersion of a catalyst 132, an electronic conductor 134, and a hydrophobic gas permeable polymer binder 136. Cathode 130 may be supported on a porous electronically conductive material, such as, for example, metal fibers or mesh (e.g., nickel and/or copper mesh), carbon or carbon nanotube fibers, ropes, bundles, mats, or fabrics, as well as other electronically conductive inorganic or organic fibers. These support materials may serve as a catalyst, provide additional mechanical support, and may serve as a current collector.

It should be understood that the electrodes described herein are composites, where the composites comprise one or more discontinuous phases (reinforcement) embedded in a continuous phase (matrix). The embedded phase can take on many forms, such as particles or fibers. The matrix serves in binding the reinforcement together, transferring loads to the reinforcement, imparting toughness to the composite, and protecting the reinforcement from environmental attack and damage due to handling.

Thus, cathode 130 may be fabricated from a catalyst ink precursor, which may be applied as a thin layer on the electronically conductive support. In one embodiment, the catalyst ink is formulated by combining catalyst 132 and electronic conductor 134 with hydrophobic gas permeable polymer binder 136. In one embodiment, binder 136 holds catalyst 132 and electronic conductor 134 together, as described above. Stated more generally, catalyst 132 and electronic conductor 134 may be operatively connected by binder 136.

Binder 136 is typically readily dissolvable in the catalyst ink solution. Thus, when thin film cathode 130 is cast, a continuous phase is formed, resulting in a cathode 130 with increased mechanical integrity, as described above.

Catalyst 132 may be comprised of, for example, MnO₂, silver, cobalt oxide, noble metals and their compounds, mixed metal compounds including rare earth metals, transition metal macrocyclics, spinels, phthalocyanines or perovskites, mercurinc oxide, silver oxide, other metal oxides, and oxidizing materials. In one embodiment, catalyst 132 is essentially free of metal hydroxides. In other words, in such an embodiment, catalyst 132 is lacking in a sufficient amount of metal hydroxides to materially affect the basic characteristics of catalyst 132. In another embodiment, catalyst 132 is not an in situ product of the reduction of potassium permanganate.

Electronic conductor 134 may be comprised of, for example, carbon in any suitable form, e.g., carbon black, graphite, fullerenes, and carbon nanotubes. In one embodiment, use of a high surface area carbon may provide oxygen reduction and serve as a catalyst for peroxide decomposition. In another embodiment, doped (e.g., nitrogen) carbon nanotubes may be used as both electronic conductor 134 and catalyst 132.

Hydrophobic gas permeable polymer binder 136 may be comprised of, for example, Nafion® (sulfonated tetrafluoroethylene copolymer, manufactured by Dupont), polysulfones, polyimides, polyketones, poly(arylene ether phosphine oxide)s, polyether ether ketone, and polyether sulfones. Other suitable binder materials are disclosed in U.S. patent application Ser. No. 11/980,873, which is incorporated by reference herein in its entirety. In one embodiment, the ratio of binder 136 to electronic conductor 134 is about 1:1. In another embodiment, the ratio of binder 136 to electronic conductor 134 may be from about 0.5:1 to about 1:0.5, or from about 0.1:1 to about 1:0.1. This ratio may be increased or decreased, e.g., to satisfy hydration retention needs. In one embodiment, binder 136 may be added to the catalyst ink solution as a dispersion.

In one embodiment, binder 136 possesses advantageous water management properties. The water management properties of binder 136 may include the ability to decrease mass transport losses by balancing flooding and water vapor loss from the electrolyte while permitting reactant transport.

In another embodiment, binder 136 provides cathode 130 with significantly increased mechanical integrity. As set forth above, binder 136 is typically readily dissolvable in the catalyst ink solution. Thus, when the thin film cathode is cast, a continuous phase is formed, resulting in a cathode 130 having increased mechanical integrity. As such, binder 136 is distinguishable over thin film electrodes that contain, for example, finely dispersed hydrophobic PTFE particles as so-called hinder materials. First, such thin film electrodes lack mechanical integrity because PTFE cannot be processed in a solution phase. They are instead created from an aqueous dispersion of PTFE particles, which results in a discontinuous agglomeration of PTFE. Such a morphology is not capable of suitably supporting mechanical loads. In fact, to create a continuous phase of PTFE, sintering would be required.

in one embodiment, hinder 136 inherently has suitable oxygen permeability to allow sufficient oxygen access to catalyst 132 to allow the chemical reactions set forth below to proceed. In another embodiment, binder 136 inherently has suitable gas permeability to assist in the alleviation of gas accumulation in the open electrochemical cell. In contrast, hydrophobic PTFE particles do not inherently provide suitable gas or oxygen permeability. Gas and oxygen permeability in thin film electrodes that contain finely dispersed hydrophobic PTFE particles results, if at all, from the porosity created by the discontinuous morphology described above.

In another embodiment, binder 136 may be ionically conductive.

Several methods are suitable to apply the cathode dispersion to the porous electronically conductive support. In a wet assembly, the methods may include, for example, pipette, pneumatic spray, dip coating, spin coating, and draw down. For a dry assembly, the cathode may be formulated by, for example, using an ionomer powder, wherein the components of the cathode may be mixed and the dry cathode mixture may be affixed to the porous electronically conductive support using pressure.

Metal-air battery 100 may further comprise one or more porous insoluble substances, such as, but not limited to, filter paper 140 and glass fiber separator 150. Filter paper 140 and glass fiber separator 150 may be saturated with potassium hydroxide solution (the aqueous electrolyte) 160. Other electrolytes, e.g., sodium chloride, sodium hydroxide, and other salts, acids and alkalis, and solid polymer electrolytes, such as ion exchange membranes, and forms (e.g., potassium hydroxide crystals activated by water) may be used. Other example porous insoluble substances suitable for use with metal-air battery 100 may include, for example, materials having good chemical stability and mechanical integrity, and which allow high ionic conductivity and low electronic conductivity. Such materials may include, for example, plastic membranes, cellulose membranes, cloth, and the like.

Metal-air battery 100 also includes anode 170. Anode 170 may be comprised of, for example, zinc, aluminum, lithium, calcium, magnesium, iron, and other reducing materials. The anode material may be present in various forms, including foils, powders, and amalgams. In one embodiment, anode 170 is essentially free of indium. In another embodiment, anode 170 is essentially free of mercury. In another embodiment, anode 170 is essentially free of organic surfactant.

Metal-air battery 100 may also include an anode current collector 180. Anode current collector 180 may be comprised of, for example, stainless steel, nickel, gold, nickel-clad stainless steel, nickel-plated stainless steel, Inconel® alloys, and other noncorrosive materials that minimize contact resistance.

Additional deliquescent and/or hygroscopic binder materials may also be used to keep the cell wet and resist dry-out. These materials may be electrosoluble to enhance ionic conductivity. The materials may also be water soluble to promote adhesion. Typical deliquescent and/or hygroscopic binder materials may include, but are not limited to, poly(ethylene maleic anhydride) copolymer, polyvinyl alcohol, 2-hydroxy cellulose, polyethylene oxide), polyethylene glycol, polyvinylpyrrolidone, polyacrylic acid, and Nafion®, as well as, in some embodiments, zinc chloride, calcium chloride, magnesium chloride, lithium chloride, calcium bromide, potassium biphosphate, sodium formate, potassium acetate, phosphorous oxide, ammonium acetate, sodium acetate, sodium silicate, magnesium acetate, potassium silicate, magnesium sulfate, aluminum oxide, calcium oxide, silicon oxide, zeolite, barium oxide, cobalt chloride, bentonite, montmorillonite clay, silica gel, molecular sieve, monohydric compounds, polyhydric compounds, metal nitrate salt, sodium ethyl-sulfate organic salt, hydrogels, and combinations thereof.

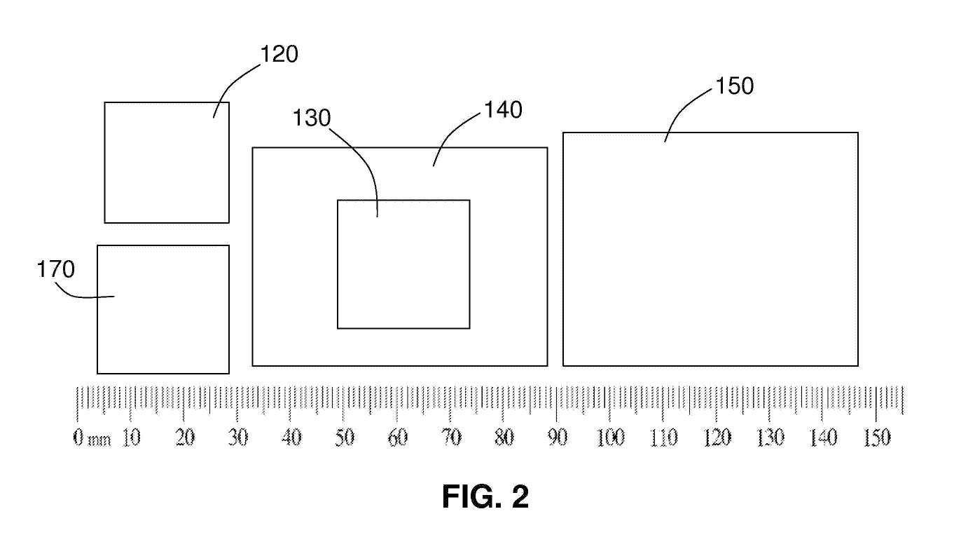

FIG. 2 illustrates an example embodiment of a zinc-air battery prior to assembly. For ease of reference, elements identified above with respect to FIG. 1 are given like numerals in FIG. 2. Specifically, zinc foil (anode 170), semi-permeable membrane 120, assembled cathode 130, cellulose filter paper 140, and glass filter separator 150 are shown. Although specific battery component dimensions are shown in FIG. 2 for illustrative purposes, it will be readily recognized by a person having ordinary skill in the art that the battery component dimensions may be scaled up or down as necessary or desired.

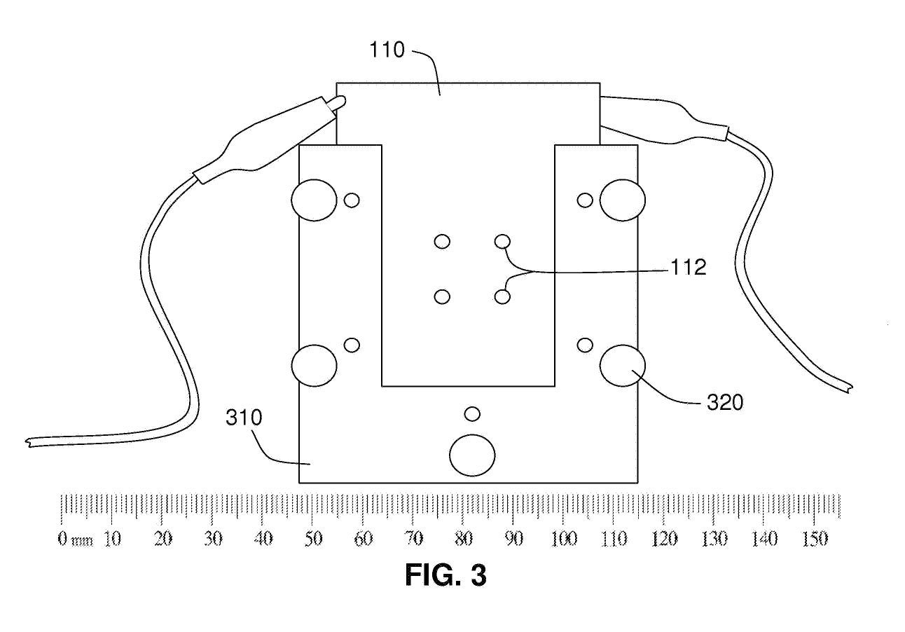

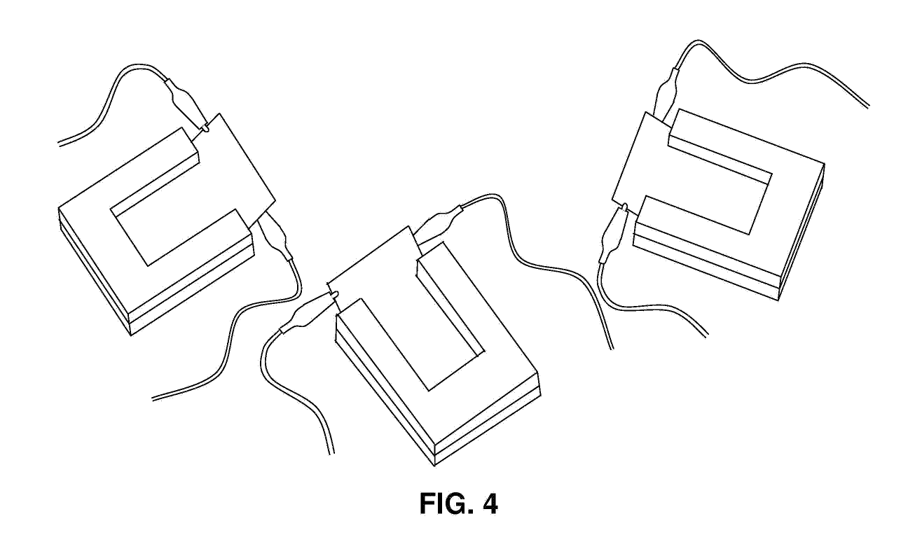

FIG. 3 illustrates an example embodiment of a zinc-air battery in an example testing fixture. The outer shell 310 is a PTFE housing piece held in place by plastic screws 320. Access ports are provided in this housing for electrolyte or water addition. Cathode current collector 110 with air holes 112 are observable from this view. Just as the battery size may be scaled up or down as necessary or desired, several batteries may be placed in series, as shown in FIG. 4.

As shown in FIG. 1, metal-air battery 100 may have an open-cell, laminated/layered design, with holes in the top of the cathode current collector. Such a cell design at least partially allows gases generated from chemical reactions occurring within the cell to exhaust at the perimeter of the cell, rather than confining the gases within the cell.

As further shown in FIG. 1, and as set forth more fully above, metal-air battery 100 comprises a cathode 130 which may comprise a dispersion of a catalyst (e.g., MnO₂) 132, an electronic conductor (e.g., graphite) 134, and a hydrophobic, gas permeable polymer binder (e.g., Nafion®) 136. The chemical reactions generated during the electrochemical operation (discharge) of metal-air battery 100 are shown below. For purposes of this example embodiment, anode 170 is zinc. The theoretical voltage is 1.65 V. The nominal voltage is 1.50 V.

Cathode ½O₂+H₂O+2e⁻→2OH− E°=0.40 V

Anode Zn→Zn²⁺+2e⁻

Zn²⁺+2OH⁻→Zn(OH)₂ E°=1.25 V

Zn(OH)₂→ZnO+H₂O

Overall reaction Zn+½O₂→ZnO E°=1.65 V

The reaction chemistry has a rate-limiting step which affects reaction kinetics and, hence, cell performance. This step relates to the oxygen reduction process, wherein peroxide-free radical (O₂H⁻) formation occurs:

Step 1 O₂+H₂O+2e⁻→O₂H⁻+OH⁻

Step 2 O₂H→OH+½O₂

### Handbook of Batteries, 3d Ed.

Thus, the configuration of cathode 130 enables metal-air battery 100 to act as a metal-air fuel cell, thereby avoiding consumption of the catalyst (e.g., MnO₂). The cell uses oxygen from ambient air as the cathode reactant. In other words, only additional anode (Zn) material is needed to increase capacity. The majority of the cell is zinc, which results in high volumetric energy density. Moreover, the cell may be mechanically recharged by replacing the discharged anode material (e.g., Zn) and the electrolyte (e.g., KOH).

This is to be compared to primary alkaline systems, which reduce metal oxide to the lower metal or a lower oxide. For example, in a conventional alkaline-MnO₂ cell, e.g., a Zn/MnO₂ cell as disclosed in U.S. Pat. No. 5,652,043 issued to Nitzan, the zinc anode is oxidized to form ZnO in an alkaline electrolyte (e.g., potassium hydroxide):

MnO₂+H₂O+e⁻→MnOOH+OH⁻

3MnOOH+e⁻→Mn₃O₄+OH⁻+H₂O

Zn+4OH⁻=Zn(OH)₄²⁻+2e⁻

Zn+2OH⁻=Zn(OH)₂+2e⁻

Zn(OH)₂=ZnO+H₂O

2MnO₂+Zn+2H₂O=2MnOOH+Zn(OH)₂

Handbook of Batteries, 3^{rd} Ed. Thus, to increase capacity of the cell, both the anode material (Zn) and the cathode material (MnO₂) must be replenished.

The following examples are provided to illustrate various embodiments and should not be considered as limiting in scope.

### Example 1

### Zinc-Air Battery

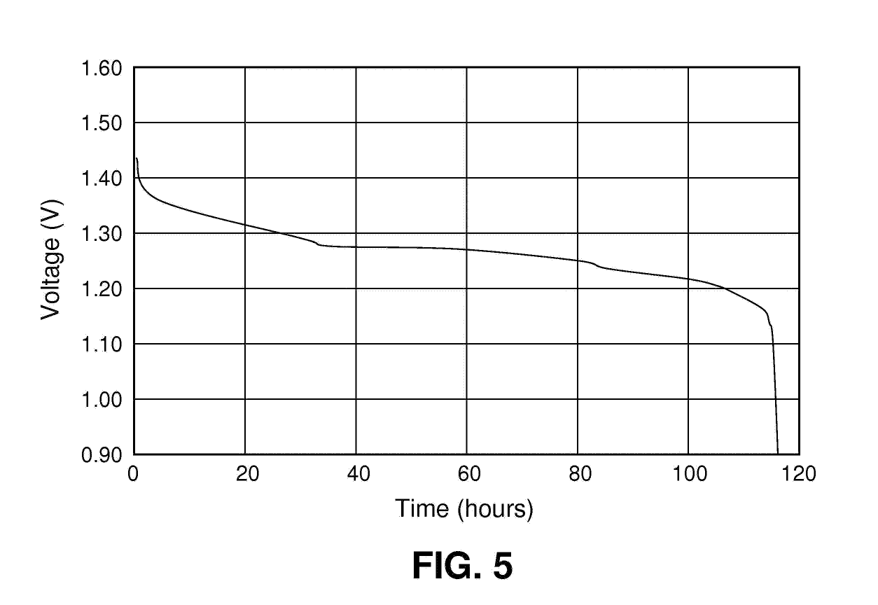

To fabricate the cathode, a dispersion containing 4.0 g of 5% Nafion® ionomer solution, 0.2 g of graphite, and 2.0 g of MnO₂ was prepared. The appearance of the solution was that of thick fountain pen ink. The cathode was created by applying and uniformly coating the dispersion onto nickel mesh (6.25 cm²), suspended under an infrared heat source. A pipette was used to apply the dispersion. Layers of the dispersion were added and dried to achieve the desired cathode weight. Commercially available 99.9+% pure zinc foil (6.25 cm²) was used for the anode. To fabricate the battery, a stainless steel current collector was placed in a battery test fixture followed by the zinc foil. On the top of the zinc foil, a separator layer measuring approximately 4 cm×5 cm comprising two cellulose filters separated by a glass filter and saturated with a 45 wt % KOH solution was applied. The cathode electrode was placed on the opposite side of the separator layer from the anode, topped by a semi-permeable membrane (less than 6.25 cm²) and a stainless steel current collector containing air holes. The open cell battery was secured in the test fixture, attached to the battery tester (Albin model BT-2000), and evaluated at a constant discharge current of 750 μA for approximately 120 hours. Example results are shown in FIG. 5.

### Example 2

### Aluminum-Air Battery

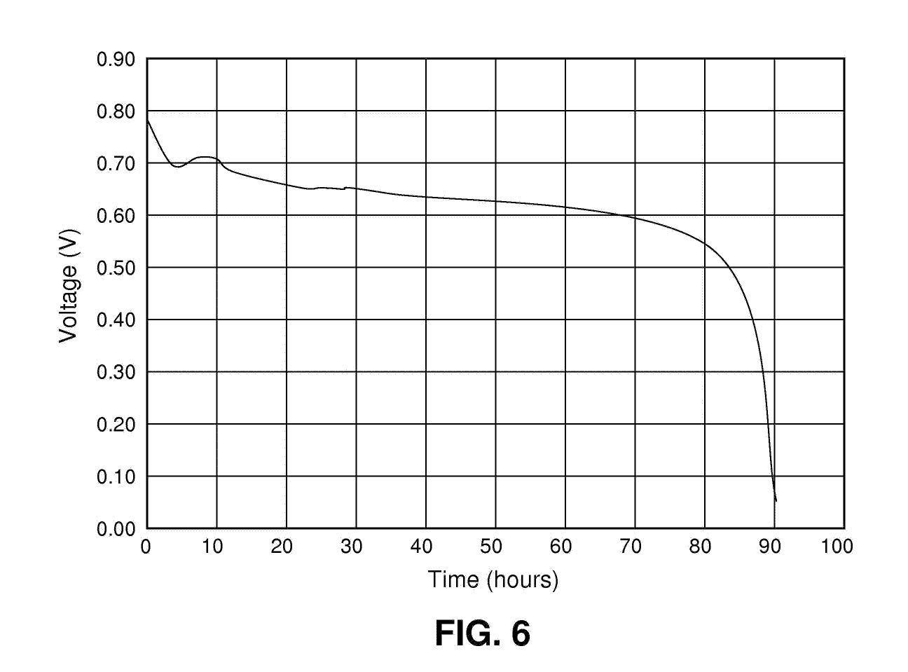

An open cell battery was prepared as described in Example 1 with the following modification. First, the zinc foil in Example 1 was replaced with aluminum foil. Second, the 45 wt % KOH electrolyte solution was replaced with a 12 wt % NaCl electrolyte solution. The battery was evaluated at a constant discharge current of 750 μA for approximately 100 hours. Example results are shown in FIG. 6.

Although the batteries of Examples 1 and 2 have been discussed in the context of a wet assembly, it is possible to fabricate the batteries in a dry assembly. For example, with reference to the battery of Example 1, dry KOH may be imbedded into the separator assembly and water may be wicked through the battery test fixture, which is designed to allow for hydration and electrolyte addition.

Unless specifically stated to the contrary, the numerical parameters set forth in the specification are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising,” as that term is interpreted when employed as a transitional word in a claim. As used herein, the phrase “operably connected” or “operatively connected” means related in such a way as to perform a function. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed is:

1. A method for operating an open electrochemical cell, comprising:
providing the open electrochemical cell, the open electrochemical cell comprising a catalyst and an electronic conductor operatively connected by a hydrophobic gas-permeable binder to form a cathode, wherein the cathode is configured to electrochemically couple to an anode material via an electrolyte material to form the open electrochemical cell; and
recharging the open electrochemical cell by adding at least one of the electrolyte material and the anode material to the open electrochemical cell.

2. The method of claim 1, wherein the open electrochemical cell is configured such that at least one of the anode material and the electrolyte material is replaceable.

3. The method of claim 1, the open electrochemical cell further comprising a discharged portion of at least one of the electrolyte material and the anode material, wherein the recharging the open electrochemical cell comprises replacing the discharged portion of at least one of the electrolyte material and the anode material by adding at least one of the electrolyte material and the anode material to the open electrochemical cell.

4. The method of claim 1, further comprising at least partly discharging the open electrochemical cell to form a discharged portion of at least one of the electrolyte material and the anode material in the open electrochemical cell, wherein the recharging the open electrochemical cell comprises replacing the discharged portion of at least one of the electrolyte material and the anode material by adding at least one of the electrolyte material and the anode material to the open electrochemical cell.

5. The method of claim 1, wherein the open electrochemical cell is incorporated in a rechargeable battery, and wherein the rechargeable battery is rechargeable by recharging the open electrochemical cell by adding at least one of the electrolyte material and the anode material to the open electrochemical cell.

6. The method of claim 1, further comprising operating the open electrochemical cell as a single cell or in series with one or more additional open electrochemical cells.

7. The method of claim 1, further comprising allowing an accumulated gas to escape from the open electrochemical cell.

8. The method of claim 1, wherein the open electrochemical cell is configured as a laminated open cell.

9. The method of claim 1, wherein the open electrochemical cell is configured as a metal-air battery.

10. The method of claim 1, wherein the catalyst comprises at least one of MnO₂, silver, cobalt oxide, a noble metal, a noble metal complex, a rare earth metal, a transition metal macrocyclic, a spinet, a phtalocyanine, a perovskite, mercuric oxide, and silver oxide.

11. The method of claim 1, wherein the electronic conductor comprises at least one of graphite, a carbon nanotube, a carbon nanotube doped with nitrogen, a fullerene, and carbon black.

12. The method of claim 1, wherein the hydrophobic gas permeable binder comprises at least one of a sulfonated tetrafluoroethylene copolymer, a polysulfone, polyimide, a polyketone, a poly(arylene ether phosphine oxide), a polyether ether ketone, and a polyether sulfone.

13. The method of claim 1, wherein the electrolyte material comprises at least one of KOH, NaOH, and NaCl.

14. The method of claim 1, wherein the anode material comprises at least one of zinc, aluminum, lithium, calcium, magnesium, and iron.

15. A method for operating an electrically powered functional device using an open electrochemical cell, comprising:
providing the functional device operatively coupled to the open electrochemical cell, the open electrochemical cell comprising a catalyst and an electronic conductor operatively connected by a hydrophobic gas-permeable binder to form a cathode, wherein the cathode is configured to electrochemically couple to an anode material via an electrolyte material to form the open electrochemical cell; and
recharging the open electrochemical cell by adding at least one of the electrolyte material and the anode material to the open electrochemical cell.

16. The method of claim 15, the open electrochemical cell further comprising a discharged portion of at least one of the electrolyte material and the anode material, wherein the recharging the open electrochemical cell comprises replacing the discharged portion of at least one of the electrolyte material and the anode material by adding at least one of the electrolyte material and the anode material to the open electrochemical cell.

17. The method of claim 15, further comprising operating the functional device by at least partly discharging the open electrochemical cell to form a discharged portion of at least one of the electrolyte material and the anode material in the open electrochemical cell, wherein the recharging the open electrochemical cell comprises replacing the discharged portion of at least one of the electrolyte material and the anode material by adding at least one of the electrolyte material and the anode material to the open electrochemical cell.

18. The method of claim 15, further comprising allowing an accumulated gas to escape from the open electrochemical cell.

19. The method of claim 15, wherein the open electrochemical cell is incorporated in a rechargeable battery, and wherein the rechargeable battery is rechargeable by recharging the open electrochemical cell by adding at least one of the electrolyte material and the anode material to the open electrochemical cell.

20. A method for operating a rechargeable metal-air battery, comprising:
providing the rechargeable metal-air battery comprising an open laminated electrochemical cell, the open laminated electrochemical cell comprising a catalyst and an electronic conductor operatively connected by a hydrophobic gas-permeable binder to form a cathode, wherein the cathode is configured to electrochemically couple to an anode material via an electrolyte material to form the open laminated electrochemical cell, at least one of the anode material and the electrolyte material being replaceable;
at least partly discharging the open laminated electrochemical cell to form a discharged portion of at least one of the electrolyte material and the anode material;
allowing an accumulated gas to escape from the open laminated electrochemical cell; and
recharging the open laminated electrochemical cell in the rechargeable metal-air battery by adding at least one of the electrolyte material and the anode material to the open electrochemical cell or replacing a discharged portion of at least one of the electrolyte material and the anode material,
wherein:
the catalyst comprises at lead one of MnO₂, silver, cobalt oxide, a noble metal, a noble metal complex, a rare earth metal, a transition metal macrocyclic, a spinel, a phtalocyanine, a perovskite, mercuric oxide, and silver oxide;
the electronic conductor comprises at least one of graphite, a carbon nanotube, a carbon nanotube doped with nitrogen, a fullerene, and carbon black;
the hydrophobic gas permeable binder comprises at least one of a sulfonated tetrafluoroethylene copolymer, a polysulfone, polyimide, a polyketone, a poly(arylene ether phosphine oxide), a polyether ether ketone, and a polyether sulfones;
the electrolyte material comprises at least one of KOH, NaOH, and NaCl; and
the anode material comprises at least one of zinc, aluminum, lithium, calcium, magnesium, and iron.
